(19) United States
(12) Patent Application Publication
(10) Pub. No.: US 2025/0198837 A1
(43) Pub. Date: Jun. 19, 2025

(54) LIGHT SENSING LOW ENERGY WIRELESS TAG

(71) Applicant: Wiliot, Ltd., Caesarea (IL)

(72) Inventors: Eylon GERSTEN, Even Yehuda (IL); Alon YEHEZKELY, Haifa (IL)

(73) Assignee: Wiliot, Ltd., Caesarea (IL)

(21) Appl. No.: 18/540,191

(22) Filed: Dec. 14, 2023

(51) Int. Cl. G01J 1/44; H02J 50/00

(52) U.S. Cl. CPC G01J 1/44; H02J 50/001

(57) ABSTRACT

A wireless Internet of Things (IoT) device for detecting light exposure is provided. The IoT device includes a light sensor having an organic active layer that detects an intensity of light; an integrated circuit (IC), wherein the integrated circuit includes an oscillating circuit that is coupled to the light sensor to output a frequency value for the detected intensity of light; and at least one harvesting antenna that harvests an ambient radio frequency (RF).

### TECHNICAL FIELD

The present disclosure generally relates to Internet of Things (IoT) devices, more particularly to integrating a light sensor in low power wireless IoT devices.

### BACKGROUND

The Internet of Things (IoT) is the inter-networking of physical devices, vehicles, buildings, and other items embedded with electronics, software, sensors, actuators, and network connectivity that enable these objects to collect and exchange data. IoT is expected to offer advanced connectivity of devices, systems, and services that go beyond machine-to-machine (M2M) communications and cover a variety of protocols, domains, and applications.

IoT can be encapsulated in a wide variety of devices such as: heart monitoring implants, biochip transponders on farm animals, automobiles with built-in sensors, automation of lighting, heating, ventilation, air conditioning (HVAC) systems, and appliances such as washer/dryers, robotic vacuums, air purifiers, ovens or refrigerators/freezers that use Wi-Fi for remote monitoring. Typically, IoT devices (or tags) encapsulate sensors configured to measure environment signals.

Most IoT tags are wireless devices that collect data and transmit such data to the cloud through a central controller or directly to the cloud. There are a few requirements to be met to allow widespread deployment of IoT tags. Such requirements include communication links, low energy consumption, low maintenance costs, and compact size.

Some common IoT tags are composed of at least two main discrete components: an Integrated Circuit (IC) or a System on a Chip (SoC) and a sensor. The IC carries the functions of powering the tag, receiving/transmitting wireless signals, and processing the receive/transmit signals. The sensor measures a physical property and converts to electric signals.

In such common implementations, the sensor is connected outside of the IC, and therefore outside of the die of the SoC. A die is a small block of semiconductor material on which a given functional circuit is fabricated. Typically, ICs are produced in large batches on a single wafer of semiconductor material through processes such as photolithography. The wafer is cut (“diced”) into many pieces, each containing one copy of the circuit. Each of these pieces is called a die. Often, the sensor is connected outside of the die due to their physical dimension and the fact that they are made of different materials. As such, the ICs and sensors cannot be fabricated as a whole part of the IC, using today's submicron fabrication technologies. For IoT tags this may be a significant limiting factor.

Moreover, currently implemented IoT tags are often limited in form factor to rigid substrates using surface mounted devices (SMD). Such semiconductor based IoT tags may be costly due to materials, facilities, techniques and more. In addition, the rigid nature of the IoT tags restricts utilization of the IoT tags to only certain surfaces or applications.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a wireless Internet of Things (IoT) device for detecting light exposure. The wireless IoT device comprises: a light sensor having an organic active layer that detects an intensity of light; an integrated circuit (IC), wherein the integrated circuit includes an oscillating circuit that is coupled to the light sensor to output a frequency value for the detected intensity of light; and at least one harvesting antenna that harvests an ambient radio frequency (RF).

Certain embodiments disclosed herein include the wireless IoT device noted above or below, further comprising: an energy harvester coupled to that least one harvesting antenna; and an energy storage coupled to the energy harvester and adapted to store harvested energy, wherein the stored harvested energy powers the IC.

Certain embodiments disclosed herein include the wireless IoT device noted above or below, further comprising: a transmitter antenna that transmits the frequency value via a communication protocol.

Certain embodiments disclosed herein include the wireless IoT device noted above or below, wherein the light sensor further comprises: an interdigital interface that supplies a bias to the light sensor, wherein the bias changes with the detected intensity of light.

Certain embodiments disclosed herein include the wireless IoT device noted above or below, wherein the light sensor further comprises: a protective layer overlaid on the organic active layer.

Certain embodiments disclosed herein include the wireless IoT device noted above or below, wherein the organic active layer is a blend of N-type and P-type organic materials.

Certain embodiments disclosed herein include the wireless IoT device noted above or below, wherein the organic active layer is applied using any one of: spin-coating, slot-die coating, blade coating, spray coating, inkjet printing, and flexographic printing.

Certain embodiments disclosed herein include the wireless IoT device noted above or below, further comprising: a substrate, wherein the light sensor and the IC are disposed on the substrate, wherein the substrate is mechanically flexible.

Certain embodiments disclosed herein include the wireless IoT device noted above or below, wherein the substrate is a thin film made of any one of: polyethylene (PE), polyethylene terephthalate (PET), polyimide (PI), polystyrene (PS), and polyester.

Certain embodiments disclosed herein include the wireless IoT device noted above or below, wherein the wireless IoT device is a battery-less wireless tag.

Certain embodiments disclosed herein include the wireless IoT device noted above or below, wherein the at least one harvesting antenna operates at a frequency band including any one of: a Bluetooth low energy (BLE) frequency band, an Industrial, Scientific, and Medical (ISM) frequency band, a frequency modulation (FM) band, and a cellular frequency band.

Certain embodiments disclosed herein also include an integrated light sensor device. The integrated light sensor device comprises: a substrate, wherein the substrate is mechanically flexible; an interdigital interface layer on the substrate, wherein the interdigital interface layer includes metallic interdigital electrodes that supply a bias; and an organic active layer of photosensitive materials that is deposited on the interdigital interface layer.

Certain embodiments disclosed herein include the device noted above or below, further comprising: a first protective layer over the organic active layer; and a second protective layer below the substrate, wherein the first protective layer and the second protective layer are fixed by a glue.

Certain embodiments disclosed herein include the device noted above or below, wherein the organic active layer is a blend of N-type and P-type organic materials.

Certain embodiments disclosed herein include the device noted above or below, wherein the organic active layer is deposited using any one of: spin-coating, slot-die coating, blade coating, spray coating, inkjet printing, and flexographic printing.

Certain embodiments disclosed herein include the device noted above or below, wherein the light sensor device is fabricated using a reel-to-reel process.

Certain embodiments disclosed herein include the device noted above or below, wherein the light sensor device is coupled to a capacitor for power.

Certain embodiments disclosed herein include the device noted above or below, wherein the light sensor device is coupled to an integrated circuit (IC) that measures change in an electrical property at the light sensor device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 a block diagram of an Internet of Things (IoT) tag according to an embodiment.

FIG. 2A is a schematic cross-sectional diagram illustrating a structure of a light sensor according to an embodiment.

FIG. 2B is a layout of an interdigital interface according to an example embodiment.

FIG. 3 a layout of a light sensor integrated IoT tag according to an example embodiment.

FIG. 4 a schematic diagram of an IoT tag designed according to the disclosed embodiments.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include an IoT tag (or IoT device) with an integrated light sensor. The integrated IoT tag with a light sensor may be fabricated on a single substrate for detecting light exposures on the IoT tag, which in return indicates light exposure on a surface or item on which the IoT tag is encapsulated on. The light sensor has multiple layers including an organic active layer of photosensitive materials on an interdigital interface. The organic active layer of the light sensor provides sensitive electrical change (capacitance and resistance) to indicate intensity of light in the vicinity of the IoT tag and the light sensor. In an embodiment, the light sensor is coupled to the SoC of the IoT tag that converts small electrical changes to frequency values that may be transmitted to a central controller or directly to a cloud computing platform.

The light sensor disclosed herein employs an organic active layer that may be readily applied to various substrates through printing and coating techniques including, for example, polymer films, conducting thin films, semiconductors, paper, and more. In an embodiment, the light sensor (also the IoT tag as a whole) may be fabricated on a mechanically flexible substrate such as, but not limited to, polyimide. It should be noted that using the organic active layer reduces fabrication complexity (e.g., substrate, technique, facility, etc.) as well as costs for the fabrication process of light sensor, and the IoT tag that integrates the light sensor. It should be further noted that reduction of complexity and cost based on the disclosed embodiments is advantageous for mass production and for effective utilization in IoT networks.

According to the disclosed embodiments, the light sensor is integrated into a low-energy IoT device (or tag) through the oscillating circuitry in the SoC. The IoT tag is a lightweight, low cost, and low power device that operates through radio frequency (RF) signal harvesting. That is, the IoT tag has one or more harvesting antennas that harvest energy from ambient signals in its vicinity without a battery to supply energy. In addition, the IoT device is configured to transmit signals (e.g., light sensing signals) using communications protocols in order to efficiently share frequency values of light intensity for further analysis at, for example, a central controller device and/or a cloud computing platform. In some implementations, low energy communications protocols, for example, but not limited to, a Bluetooth low energy (BLE) protocol may be utilized for transmission of signal packets. It should be noted that the light sensor integrated IoT tag provides a low cost IoT tag that not only accurately detect light exposure but has low power consumption, small form factor, and is communicatively connected for versatile implementation in various applications.

One example usage of sensor integrated IoT tags is for monitoring goods or groups of goods and their surroundings at various stages of a supply chain, for example, transit, storage, display at storefront, and more. Current solutions to monitor such goods (or items) do not allow closed monitoring of item and environment conditions without exhausting resources such as, but not limited to, manual labor, expensive devices, restricted systems, and more. Moreover, monitoring is performed in bulks (e.g., a warehouse, a room, etc.) rather than of individual items or small groups of items. The low cost integrated IoT tag disclosed herein may be attached to small groups or individual items for efficient detection of light exposure with granularity from the surrounding environment at various stages of the supply chain. Moreover, the connected network allows further analysis of sensed signals for accurately determining surrounding conditions for the small group of individual items.

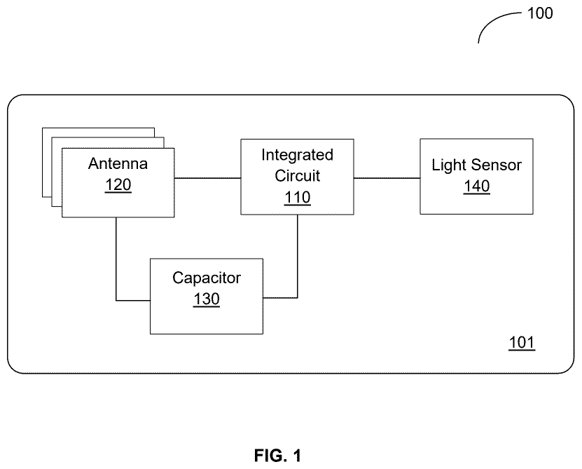

FIG. 1 is a block diagram of an Internet of Things (IoT) tag 100 according to an embodiment. The IoT tag 100 includes an Integrated Circuit (IC) 110, one or more antennas 120, a capacitor 130, and a light sensor 140. In an embodiment, the various components of the IoT tag 100 may be fabricated on a single substrate 101. In another embodiment, the one or more components may be on a different substrate and later combined into a single IoT tag 100 by combination of layers.

The one or more antennas 120 may be loop antennas that are configured as at least a transmitter antenna (or a receive/transmit antenna) to receive and transmit wireless signals using a communication protocol of the IoT tag 100. The communication protocol may include, for example, but not limited to, Wi-Fi®, WiGig®, BLE, third generation (3G) cellular, long-term evolution (LTE) cellular, frequency modulation (FM), and the like. In some implementations, the transmitter antenna communicates over Bluetooth Low Energy (BLE) communication protocols at, for example, 2.400-2.4835 GHz signal range. In an example embodiment, a designated antenna (one of the plurality of antennas 120) is utilized as a transmit/receive antenna.

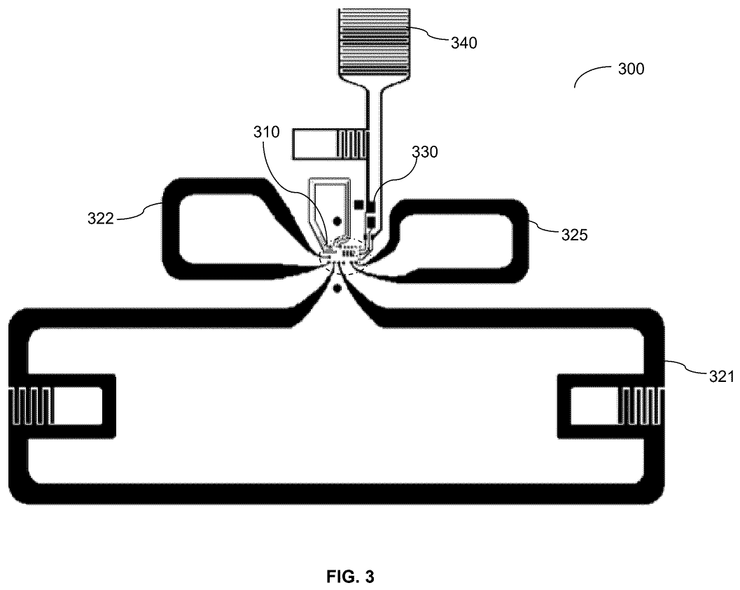

The one or more antennas 120 may include at least one harvest antenna that harvest energy from ambient electromagnetic (EM) sources and wireless signals used in various communication protocols. As an example, the harvest antenna may operation at various frequency bands such as, but not limited to, a Bluetooth low energy (BLE) frequency band, an Industrial, Scientific, and Medical (ISM) frequency band, a frequency modulation (FM) band, cellular frequency band, and the like, and more. The IoT tag 100 may include a plurality of antennas each configured to harvest energy at different frequency bands and/or to transmit data. In an example embodiment, the IoT tag 100 includes two harvesting antennas, one at 0.9 GHz and another at 2.4 GHz. The IoT tag 100 operates without a battery or any other external power source. The energy to power the IoT tag 100 is harvested from the ambient over-the-air signals and is stored in an energy storage, such as the capacitor 130. The capacitor 130 is external to and connected to the IC 110. In some implementations, the capacitor 130 may be integrated in the IC 110. An example layout of the IoT tag 100 is shown in FIG. 3.

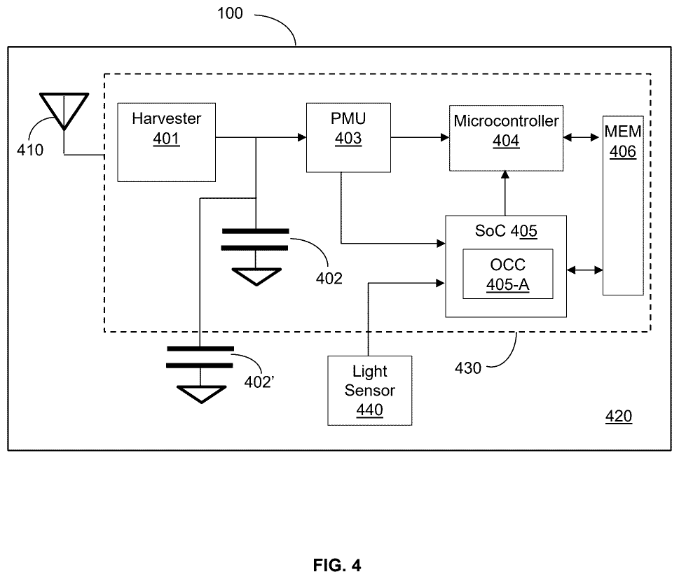

The IC 110 includes a number of execution functions realized as analog circuits, digital circuits, or both. As an example, the IC 110 may include a sensor, or other devices, capable of recording and reporting environmental conditions, an actuator, or other devices, capable of causing change in a separately connected device or an aspect of the IC 110 environment, a multifunctional device capable of both recording and influencing aspects of the IoT environment, and the like. In an embodiment, the IC 110 is configured to receive and transmit wireless signals using a low energy communication protocol such as, but not limited to, the BLE communication standard. In a further embodiment, the IC 110 includes an oscillating circuit that produces periodic signals based on detected electronic signals to indicate change in electrical properties as frequency values. An example schematic diagram of the IoT tag 100 and various components of the IC 110 (within a die 430) is shown in FIG. 4.

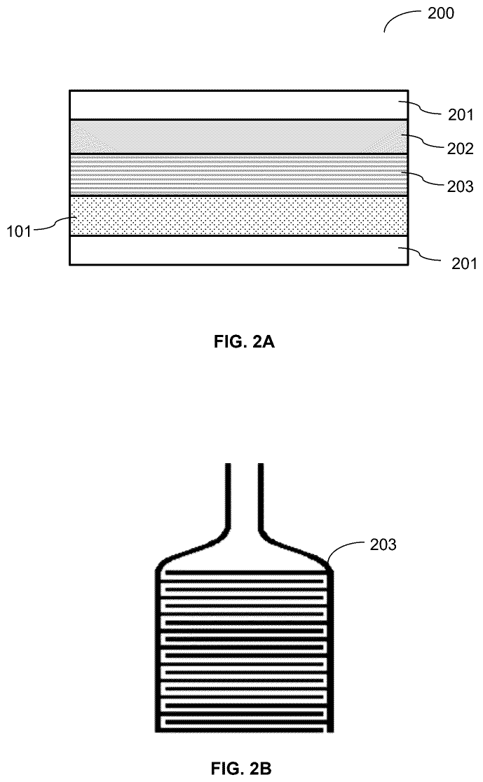

The light sensor 140 is a device configured to measure light exposures (e.g., intensity or energy of incident light) from the surrounding environment. The light sensor 140 is positioned on the substrate 101 and integrated in the IoT tag 100. To this end, the light exposures measured by the light sensor 140 measure the light exposures on the IoT tag 100. In an embodiment, the light sensor 140 may be realized by deploying organic photosensitive materials as an active layer on an interdigital interface (or electrodes). The interdigital interface supplies a bias to the light sensor. When the incident light interacts with the photosensitive materials of the active layer, a change in resistance and capacitance may occur and be measured. The electrical changes may be measured by the change in resistance, capacitance, or both. The light sensor 140 includes multiple layers as further described herein with respect to FIG. 2. In some implementations, the light sensor 140 may be a portion of the IC 110 of the IoT tag 100.

According to the disclosed embodiments, the light sensor 140 is coupled to the IC 110 including the oscillating circuit that converts the change in electrical properties (resistance, capacitance, or both) to frequency values. The conversion using the oscillating circuit allows high read-resolution of small electrical changes. Such frequency values that are output from the oscillating circuit may be processed within the IC 110 to generate packets and transmit using the respective communication protocol (e.g., the BLE protocol) via the transmitter antenna. The generated packets may include other signals detected or measured by one or more sensors deployed on the IoT tag 100.

It should be noted that the IoT tag 100 that integrates the various components, including the light sensor 140, may be fabricated or printed on the single substrate 101. By deploying organic photosensitive materials as the active layer, the material type of the substrate 101 may be unconstrained to range from, for example and without limitation, flexible to hard substrate materials. In some implementations, the integrated IoT tag 100 may be fabricated on a flexible and transparent substrate, such as polyethylene terephthalate (PET), that easily conforms to the shape of the item on which it is affixed. Other examples of substrate 101 may include polymer thin films, paper, and more, and any combination thereof. As an example, the IoT tag 100 may be attached to a spherical product to detect light exposures (and other information) on the specific product at various stages of the supply chain. It should be noted that such implementations not only allow accommodation in various applications and objections, but also reduces cost for fabrication of the resulting IoT tag 100. The integrated IoT tag 100 may be created in large bulks by, for example, but not limited to, reel-to-reel processing for scaled-up fabrication and mass production.

In some implementations, one or more IoT tags 100 are placed on a surface of, for example, but not limited to, a cart, a pallet, a case, a box, a container, an item, and the like. The IoT tag 100 may be glued, attached, or fastened to the surface. The number of IoT tags 100 on the surface depends on, for example, but not limited to, size, type, shape, and the like, and any combination thereof, of the surface. The items may be any type of product or object ranging from groceries to fashion items.

As an example, an IoT tag 100 that is integrated with the light sensor 140 is attached (e.g., glued, strapped, clipped, etc.) to a case of tomatoes. The light sensor 140 measures incident lights in the surrounding environment of the IoT tag 100 and thus, the affixed case of tomatoes. Information about light exposures may be collected, for example, intermittently, periodically, and the like, at different stages of the supply chain such as loading, transit, storage, and more. The frequency of sensing light exposure using the light sensor 140 may be predetermined for each IoT tag or a group of IoT tags. In another example, the IoT tag 100 may be fabricated as a sticker form and applied to a wool coat.

It should be noted that the disclosed integrated IoT tag allows monitoring light exposure of individual items and small groups of items at various locations and stages of the supply chain. It has been identified that the environmental conditions, such as light exposure, may vary between different rooms, sections, or specific placement in a location. For example, the light exposures may be different in various locations within the warehouse: a dark room, a brightly lit room, an item inside a closed box, and the like. In another example, certain items with the integrated IoT tag may be stored under a lamp whereas other items may be stored away from the lamp, under multiple racks of items. The small, low cost IoT tag may be placed on any item to detect light exposure of individual items and for more granular sensing. It should be noted that such indication of light exposure on individual items may be advantageous particularly for items such as, but not limited to, food items, light sensitive products, and the like.

One of ordinary skill in the art would understand that the description with respect to the supply chain is used for illustrative purposes and does not limit the scope of the disclosed embodiments. The disclosed embodiments may be applied in various applications and industries where monitoring light exposures is desired with the added benefit of small, adaptable, and low energy wireless devices.

FIG. 2A is an example schematic cross-sectional diagram 200 illustrating a structure of a light sensor according to an embodiment. The cross-sectional diagram 200 of the light sensor (e.g., the light sensor 140, FIG. 1) includes multiple layers that are stacked on top of each other. The multiple layers include a protective layer 201, a photosensitive material layer 202, an interdigital interface 203, and a substrate layer 101.

The substrate layer 101 is a common layer between various components of the IoT tag (e.g., the IoT tag 100, FIG. 1) as discussed above in FIG. 1. The substrate layer 101 is a common substrate for the light sensor and at least one component of the IoT tag 100. In some implementations, the one or more components of the IoT tag 100 may be attached to the substrate layer 101 after fabrication in order to fabricate the integrated IoT tag. The substrate may be a mechanically flexible film-like material such as, but not limited to, polyethylene terephthalate (PET), polyimide (PI), polyesters, and the like, and more. The substrate layer 101 may be treated using standard device fabrication procedures, for example, to insulate the top of the substrate layer 101 prior to further deposition.

The interdigital interface 203 is fabricated on the substrate layer 101. The interdigital interface 203 includes comb-shaped metallic electrodes (positive and negative electrodes) that are interlocked with each other. An example layout of the interdigital interface 203 is shown in FIG. 2B. The interdigital interface 203 is adapted to supply a bias to the light sensor, thereby enabling detection of electrical property changes from exposures to the surrounding light.

The photosensitive material layer 202 is overlayed on the interdigital interface 203 for interaction with incident light in order to detect light exposed to the light sensor and thus, the integrated IoT tag. The photosensitive material layer 202 or an active layer is a layer of organic photosensitive (or photoactive) materials that include a blend of donor and acceptor materials. That is, the photosensitive material layer 202 is a mixture of n-type and p-type organic materials that are often used as active layers in organic photovoltaic (OPV) devices. The photosensitive material layer 202 may be a polymer-fullerene blend, a polymer blend, polymer-molecule blend, and the like, and more, at various ratios. Examples of the photosensitive material layer 202 includes, without limitation, Poly (3-hexylthiophene-2,5-diyl) (P3HT) and Phenyl-C61-butyric acid methyl ester (PCBM), PBDB-T and ITIC, and more. A mixture of the photosensitive materials may be applied to the interdigital interface 203 using techniques such as, but not limited to, spin-coating, slot-die coating, blade coating, spray coating, inkjet printing, flexographic printing, and the like, and more. In an example embodiment, the photosensitive material layer 202 may be less than 0.5 μm thick. It should be noted that the techniques used for applying the photosensitive material layer 202 further eliminates restrictions to the shape of the substrate layer 101.

The light sensor may further include protective layers 201 on top of the photosensitive material layer 202 and optionally at the bottom of the substrate layer 101 to protect the multiple layers of the light sensor from, for example, contamination, oxidation, deformation, and the like. The protective layer 201 may be a thin film, barrier film, that does not interfere with interaction between the incident light and the photosensitive material of the active layer. The protective layer 201 may be applied using, for example, a glue, a resin, or the like, on the top and/or bottom of the light sensor.

As noted above the light sensor is integrated as a portion of the IoT tag that may be placed on a surface of, for example, an item, a case, a pallet, and the like, and any combination thereof. In some implementations, the integrated IoT tag is fabricated on a mechanically flexible substrate. Its small form factor and mechanical flexibility enable placement on various shaped surfaces without restriction. The light sensor is coupled to the oscillating circuit of the IoT tag in order to translate the change in electrical properties (e.g., capacitance and/or resistance) to a frequency value. The change in electrical properties is caused and measured by the incident light on the light sensor and thus, represents the light exposures experienced by the IoT tag from the surrounding environment. In an example embodiment, the light sensor sufficiently measures indoor lights from 1 lux to 1000 lux. The frequency values indicating sensing signals may be sent from the IoT tag via low energy communication protocols (e.g., the BLE protocol).

FIG. 3 is an example layout 300 of a light sensor integrated IoT tag according to an example embodiment. The IoT tag includes an IC (or SoC) 310, harvesting antennas 321 and 322, a transmit antenna 325, a capacitor 330, and a light sensor 340. The various components may be integrated on a single substrate for utilization of the wireless IoT tag. In the example layout 300, each harvesting antenna 321 and 322 harvest ambient electromagnetic (EM) signals at different frequencies, for example, at 0.9 GHZ by antenna 321 and at 2.4 GHz by antenna 322. The various components disclosed in layout 300 are positioned on a single substrate for utilization as an IoT tag. It should be noted that the IoT tag described herein has a small form factor and may be fabricated on various substrates. It should be further noted that the IoT tags may be mass produced, for example, by reel-to-reel processing, at low cost for usage in various applications.

FIG. 4 shows an example schematic diagram of an IoT tag 100 designed according to the disclosed embodiments. The IoT tag 100, as schematically demonstrated in FIG. 4, includes an energy harvester (harvester) 401, coupled to an on-die capacitor 402 and an external passive capacitor 402′, a power management unit (PMU) 403, a microcontroller 404, a system on chip (SoC) 405, a retention memory 406, and a light sensor 440. In some implementations, the harvester 401 may be coupled to any one of the on-die capacitor 402 and the external capacitor 402′. The IoT tag 100 further may include at least one antenna 410 glued to a substrate 420, for example. In another embodiment, the antenna 410 may be printed or etched onto the substrate 420. In a further embodiment, a passive external capacitor may take the place of the antenna 410. In an embodiment, substrate 420 is made of a low-cost material, such as, but not limited to, polyethylene (PE), polyethylene terephthalate (PET), polyimide (PI), polystyrene (PS), and more. In another embodiment, the substrate's 420 patterns (layout) may be any of aluminum, copper, or silver. The glue utilized to glue the die and/or antenna 410 may include materials such as an anisotropic conductive film (ACP), any type of conductive glue, solder paste, and the like.

In the embodiment shown in FIG. 4, the antenna 410 is coupled to the harvester 401 and may be utilized for energy harvesting as well as wireless communication. In some embodiments, multiple antennas may be utilized to harvest energy at multiple frequency bands. The antennas to harvest energy are coupled to the harvester 401. Other embodiments may include one or more antennas for energy harvesting and an antenna to receive/transmit wireless signals at the BLE frequency band. In some embodiments, the IoT tag includes a printed battery.

The SoC 405, also referred to as the Integrated Circuit (IC) includes a number of execution functions realized as analog circuits, digital circuits, or both. Examples of such execution functions are provided below. The SoC 405 is also configured to carry out processes independently or under the control of the microcontroller 404. Each process carried out by the SoC 405 also has a state, and processes may communicate with other processes through an IPC protocol. In the configuration illustrated in FIG. 4, the SoC 405 and/or the microcontroller 404 load the context of processes and reads data from the retention memory 406.

The SoC 405 is partitioned into multiple power domains. Each power domain is a collection of gates powered by the same power and ground supply. To reduce the power consumption, only one power domain is turned on during execution. The SoC 405 may perform functions, such as reading from and writing to memory, e.g., of peripherals, and may execute simple logic operations; tracking power level of the SoC 405; generating and preparing data packets for transmission; cyclic redundancy check (CRC) code generation; packet whitening; encrypting/decrypting and authentication of packets; converting data from parallel to serial; and staging the packet bits to the analog transmitter path for transmission.

In a preferred embodiment, the SoC 405 includes an oscillator calibration circuit (OCC) 405-A. The OCC 405-A includes at least one frequency locking circuit (FLC), each of which is coupled to an oscillator (both are not shown). The FLC calibrates the frequency of an oscillator using an over-the-air reference signal. In an embodiment, the calibration of the respective oscillator is performed immediately prior to a data transmission session and remains free running during the data transmission session. The FLC may be realized using frequency locked loop (FLL), a phased locked loop (PLL), and a delay locked loop (DLL). An example implementation of an oscillator calibration circuit 405-A is discussed in U.S. Pat. No. 10,886,929, assigned to the common assignee Yehezkely, and incorporated herein by reference. The OCC 405-A may be configured as the oscillating circuit that converts electrical property (e.g., capacitor and/or resistance) changes of the light sensor 440 to frequency values. In some implementations, the SoC 405 may include a separate oscillating circuit for such conversion of electrical change that is detected at the light sensor 440.

According to the disclosed embodiments, the energy harvester 401, the capacitor 402, PMU 403, microcontroller 404, SoC 405, and retention memory 406 are integrated in a die 430. The die 430 is glued to the substrate 420 that includes, for example, but not limited to, antennas 410, external capacitor 402′, and the light sensor 440. The IoT tag 100 does not include any external DC power source, such as a battery. In an embodiment, the antennas 410, external capacitor 402′, the light sensor 440, and any metal connector may be directly etched or printed on the substrate 420, thereby allow facilitated manufacturing of the low cost wireless IoT tag 100.

In an embodiment, the microcontroller 404 implements electronic circuits (such as, memory, logic, RF, etc.) performing various functions allowing communication using a low energy (power) communication protocol. Examples for such a protocol includes, but are not limited to, Bluetooth®, LoRa, Wi-Gi®, nRF, DECT®, Zigbee®, Z-Wave, EnOcean, and the like. In a preferred embodiment, the microcontroller 404 operates using a Bluetooth Low Energy (BLE) communication protocol.

In some embodiments, the microcontroller 404 is integrated with wireless sensors (not shown) to complete an IoT device's functionality.

The light sensor 440 is coupled to the SoC 405 that includes an oscillating circuit. The change in electrical properties detected with incident light at the light sensor is measured at the SoC 405 to generate and out frequency values. As noted above, the light sensor 440 is fabricated on the substrate 420 for integration with the die 430, thereby forming a small form factor IoT tag 100.

The harvester 401 is configured to provide multiple voltage levels to the microcontroller 404, while maintaining a low loading DC dissipation value. In an example implementation, the energy harvester 401 may include a voltage multiplier coupled to the antenna 410. The voltage multiplier may be a Dickson multiplier, while the antenna 410 is a receive/transmit antenna of the microcontroller 404. That is, in such a configuration, the antenna is primarily designed to receive and/or transmit wireless signals according to the respective communication protocol of the low-energy IoT tag 100 (e.g., 2.400-2.4835 GHz signal for BLE communication).

It should be noted that the antenna 410 may also be designed for energy harvesting and may operate on a different frequency band, direction, or both, than those defined in the standard of the respective communication protocol. Regardless of the configuration, energy may be harvested from any wireless signals received over the air. Alternatively, energy may be harvested from any other sources, such as solar, piezoelectric signals, and the like.

The harvested energy is stored in the on-die capacitor 402 and/or the external capacitor 402′. The PMU 403 is coupled to the capacitor 402 and is configured to regulate the power to the microcontroller 404 and SoC 405. Specifically, as the capacitance of the capacitor 402 is very limited, the power consumption should be carefully maintained. This maintenance is performed to avoid draining of the capacitor 402, thus resetting the microcontroller 404. The PMU 403 may be realized using a Schmitt trigger that operates on a predefined threshold (Vref), e.g., Vref=0.85V.

In another embodiment, the PMU 403 may be further configured to provide multi-level voltage level indications to the microcontroller 404. Such indications allow the microcontroller 404 to determine the state of a voltage supply at any given moment when the capacitor 402 charges or discharges. According to this embodiment, the PMU 403 may include detection circuitry controlled by a controller. The detection circuity includes different voltage reference threshold detectors, where only a subset of such detectors is active at a given time to perform the detection.

The IoT tag 100 does not include any crystal oscillator providing a reference clock signal. According to an embodiment, the reference clock signal is generated using over-the-air signals received from the antenna 410. As noted above, in a typical deployment, a free-running oscillator is locked via a Phase-Locked Loop (PLL) to a clock, originating from a crystal oscillator. According to the disclosed embodiments, the OCC 405-A calibrates the frequency of an oscillator using an over-the-air reference signal. The oscillator(s) implemented in the tag are on-die oscillators and may be realized as a digitally controlled oscillator (DCO).

The retention memory 406 is a centralized area that is constantly powered. Data to be retained during low power states is located in the retention memory 406. In an embodiment, the retention area is optimized to subthreshold or near threshold voltage, e.g., 0.3V-0.4V. This allows for the reduction of the leakage of the retention cells.

In some implementations, the light sensor integrated IoT tag may communicate with a cloud computing platform via a central controller, a gateway device (edge computing device), or directly. The central control and/or gateway device communicates with the cloud computing platform via the Internet or a network. The IoT tag is configured to transmit light sensor sensing signals as frequency values to the gateway device using low power communication protocol (e.g., the BLE protocol). The gateway device creates data packets to relay IoT tag signals to the cloud computing platform to be analyzed. The cloud computing platform may include a server and a database. The server receives data packets to extract sensing signals and metadata to determine a level of light exposure. The analysis in the server correlates change of electrical property (capacitance or resistance) as a level of light exposure, which may be based on predetermined baseline and calibrations. The server may be realized as a physical machine, a virtual machine, or a combination thereof.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A wireless Internet of Things (IoT) device for detecting light exposure, comprising:
a light sensor having an organic active layer that detects an intensity of light;
an integrated circuit (IC), wherein the integrated circuit includes an oscillating circuit that is coupled to the light sensor to output a frequency value for the detected intensity of light; and
at least one harvesting antenna that harvests an ambient radio frequency (RF).

2. The wireless IoT device of claim 1, further comprising:
an energy harvester coupled to that least one harvesting antenna; and
an energy storage coupled to the energy harvester and adapted to store harvested energy, wherein the stored harvested energy powers the IC.

3. The wireless IoT device of claim 1, further comprising:
a transmitter antenna that transmits the frequency value via a communication protocol.

4. The wireless IoT device of claim 1, wherein the light sensor further comprises:
an interdigital interface that supplies a bias to the light sensor, wherein the bias changes with the detected intensity of light.

5. The wireless IoT device of claim 1, wherein the light sensor further comprises:
a protective layer overlaid on the organic active layer.

6. The wireless IoT device of claim 1, wherein the organic active layer is a blend of N-type and P-type organic materials.

7. The wireless IoT device of claim 1, wherein the organic active layer is applied using any one of: spin-coating, slot-die coating, blade coating, spray coating, inkjet printing, and flexographic printing.

8. The wireless IoT device of claim 1, further comprising:
a substrate, wherein the light sensor and the IC are disposed on the substrate, wherein the substrate is mechanically flexible.

9. The wireless IoT device of claim 8, wherein the substrate is a thin film made of any one of: polyethylene (PE), polyethylene terephthalate (PET), polyimide (PI), polystyrene (PS), and polyester.

10. The wireless IoT device of claim 1, wherein the wireless IoT device is a battery-less wireless tag.

11. The wireless IoT device of claim 1, wherein the at least one harvesting antenna operates at a frequency band including any one of: a Bluetooth low energy (BLE) frequency band, an Industrial, Scientific, and Medical (ISM) frequency band, a frequency modulation (FM) band, and a cellular frequency band.

12. An integrated light sensor device, comprising:
a substrate, wherein the substrate is mechanically flexible;
an interdigital interface layer on the substrate, wherein the interdigital interface layer includes metallic interdigital electrodes that supply a bias; and
an organic active layer of photosensitive materials that is deposited on the interdigital interface layer.

13. The device of claim 12, further comprising:
a first protective layer over the organic active layer; and
a second protective layer below the substrate, wherein the first protective layer and the second protective layer are fixed by a glue.

14. The device of claim 12, wherein the organic active layer is a blend of N-type and P-type organic materials.

15. The device of claim 12, wherein the organic active layer is deposited using any one of: spin-coating, slot-die coating, blade coating, spray coating, inkjet printing, and flexographic printing.

16. The device of claim 12, wherein the light sensor device is fabricated using a reel-to-reel process.

17. The device of claim 12, wherein the light sensor device is coupled to a capacitor for power.

18. The device of claim 12, wherein the light sensor device is coupled to an integrated circuit (IC) that measures change in an electrical property at the light sensor device.
